(19) United States
(12) Patent Application Publication
(10) Pub. No.: US 2021/0286079 A1
(43) Pub. Date: Sep. 16, 2021

(54) DISTRIBUTED LIGHT DETECTION AND RANGING (LIDAR) MANAGEMENT SYSTEM

(71) Applicant: SZ DJI TECHNOLOGY CO., LTD., Shenzhen (CN)

(72) Inventors: Xiang Liu, Shenzhen (CN); Xiaoping Hong, Shenzhen (CN); Fu Zhang, Shenzhen (CN); Han Chen, Shenzhen (CN); Chenghui Long, Shenzhen (CN); Xiaofeng Feng, Shenzhen (CN)

(73) Assignee: SZ DJI Technology Co., Ltd.

(21) Appl. No.: 17/333,573

(22) Filed: May 28, 2021

Related U.S. Application Data
(63) Continuation of application No. PCT/CN2018/118161, filed on Nov. 29, 2018.

(51) Int. Cl. G01S 17/87; G01S 17/931; G05D 1/02; G01S 7/00

(52) U.S. Cl. CPC G01S 17/87; G01S 7/003; G05D 1/024; G01S 17/931

(57) ABSTRACT

Disclosed herein are techniques for implementing a distributed sensor (LIDAR) system with a management system (e.g., a controller) that controls and interfaces with multiple sensors in the distributed sensor system. A representative management system can control an operational state (e.g., power on, reset, over-current protection, etc.), an operating mode (e.g., modes corresponding to varying levels of performance), etc. The management system can combine separate outputs from the individual sensors into a combined output (e.g., point cloud). The management system can assist installation of the sensors, manage a self-test and/or a self-calibration of the sensors, or a combination thereof.

### TECHNICAL FIELD

The present technology is directed generally to system management, and more specifically, to managing associated components, devices, processes, and techniques in light detection and ranging (LIDAR) applications.

### BACKGROUND

With their ever-increasing performance and lowering cost, many vehicles (e.g., autonomous self-driving vehicles, vehicles configured to perform computer-assisted maneuvers or self-driving maneuvers, unmanned aerial vehicles (UAVs), and/or other autonomously mobile devices) are now extensively used in many fields. For example, UAVs are often used to perform crop surveillance, real estate photography, inspection of buildings and other structures, fire and safety missions, border patrols, and product delivery, among others. Also, road-vehicles are now configured to autonomously perform parallel-parking maneuvers, and in some limited environments, conduct fully autonomous driving.

For obstacle detection as well as for other functionalities, it is beneficial for such vehicles to be equipped with obstacle detection and surrounding environment scanning devices. Light detection and ranging (LIDAR, also known as “light radar”) is a reliable and stable detection technology because it is able to function under nearly all weather conditions. Traditional LIDAR devices are typically large in size and expensive because they are each configured to provide a full 360° view around the vehicle. Typically, many LIDAR/radar systems include rotary transmitters/receivers placed on the roof of the vehicle. Such traditional designs may limit the width of the measurement range unless the LIDAR/radar is mounted high on the vehicle, which may negatively affect the vehicle's appearance. Accordingly, there remains a need for improved techniques and systems for implementing LIDAR scanning modules carried by autonomous vehicles and other objects.

### SUMMARY

The following summary is provided for the convenience of the reader and identifies several representative embodiments of the disclosed techniques. A representative system for detecting an environment around a mobile platform includes:
(1) a plurality of distance measurement devices (e.g., including one or more LIDAR devices), with individual distance measurement devices coupled to the mobile platform at corresponding different locations (e.g., of the mobile platform, two or more of: an upper portion, a lower portion, a front portion, a rear portion, a central portion, or a side portion), wherein the individual distance measurement devices are configured to generate corresponding individual distance measurement data sets (e.g., point cloud data that correspond to different individual coordinate reference frames) representative of distances between the mobile platform and features of the environment; and
(2) a controller coupled to the plurality of distance measurement devices, wherein the controller comprises: an interface to an external computing device, and wherein the controller is configured to:
   (a) receive the individual distance measurement data sets from the plurality of distance measurement devices,
   (b) calculate (e.g., based on converting the individual distance measurement data sets into a single coordinate reference frame, synchronizing at least some distance measurement data sets based on vehicle velocity and/or data timestamp), based on the individual distance measurement data sets, a combined distance measurement data set representative of at least a portion of the environment around the mobile platform and covering a larger field of view than the individual distance measurement data sets,
   (c) communicate the combined distance measurement data set to the external computing device via the interface, receive status data (e.g., one or more of power data or error data for the at least one distance measurement device) from at least one distance measurement device,
   (d) transmit a control signal in response to the status data, receive context data indicative of a state of one or more of the mobile platform or the environment, and/or
   (e) transmit a mode switch signal to the plurality of distance measurement devices in response to the context data, wherein the mode switch signal causes the plurality of distance measurement devices to operate according to an operating mode (e.g., a high performance mode, a low performance mode, a balanced performance mode, a sleep mode, or a user-defined custom mode).

As an example, when the context data indicates that the mobile platform is stationary and/or idling, the controller can transmit the mode switch signal that causes the plurality of distance measurement devices to operate in a low performance mode or a sleep mode. As another example, when the context data indicates that the mobile platform is operating in a high complexity environment and/or at a high velocity, the controller can transmit the mode switch signal that causes the plurality of distance measurement devices to operate in a high performance mode. In some cases, the velocity of the mobile platform can be calculated based on initially processing (e.g., via an initial or a parallel processing routine) the sensor data.

In some embodiments, the controller may include a printed circuit board (PCB) with a processing circuit, a control hub, a data hub, one or more interfaces, or a combination thereof attached thereon. The control hub may be configured to communicate one or more control signals, one or more status data, or a combination thereof to or from the plurality of distance measurement devices. The data hub may be configured to receive and process the individual distance measurement data sets from each of the plurality of distance measurement devices. The processing circuit may be configured to control the control hub and/or the data hub. The controller may be further configured to calculate, based on the individual distance measurement data sets, a combined distance measurement data set representative of at least a portion of the environment around the mobile platform. One or more of the interfaces may communicate the combined distance measurement data set to an external computing device. The controller may be further configured to receive and process the status data that includes one or more of power data or error data for the at least one distance measurement device. The controller may further receive and process sensor data from at least one other sensor (e.g., a GPS sensor, an IMU, a stereovision camera, a barometer, a temperature sensor, or a rotary encoder) coupled to the mobile platform. In some cases, the mobile platform associated with the controller may be an unmanned vehicle, an autonomous vehicle, or a robot.

In one or more embodiments, the system may include a power supply and a plurality of protection circuits, wherein the individual distance measurement devices are connected to the power supply via corresponding individual protection circuits. The status data can include the power data, which can further include a voltage value at the at least one distance measurement device and/or a current value between the power supply and the at least one distance measurement device. If the current value exceeds a threshold value, the control signal may be transmitted to the corresponding protection circuit to cause the protection circuit to disconnect the at least one distance measurement device from the power supply. In some cases, the status data can include the error data (e.g., one or more of temperature data, voltage data, or self-test data) that is indicative of whether the at least one distance measurement device is in an error state. If the error data indicates that the at least one distance measurement device is in the error state, the control signal may be transmitted to the at least one distance measurement device to cause the at least one distance measurement device to reboot. In some embodiments, to reduce a transient current peak associated with initiating the plurality of distance measurement devices, the system may be configured to implement a staggered initiation sequence for the plurality of distance measurement devices by initiating (e.g., powering up) at least one distance measurement device before another distance measurement device.

In some instances, the controller, the power supply and/or the plurality of protection circuits can set an order of priority for one or more of the distance measurement devices. For example, forward-facing LIDAR may be given a higher priority than side-facing and/or rear-facing LIDAR devices for road vehicles that primarily travel in the forward direction. Accordingly, when an abnormal incident occurs (e.g., low power/fuel), the controller, the power supply and/or the plurality of protection circuits can operate the distance measurement devices according to the priority to ensure sustained navigation/travel. As such, the controller can shut down the distance measurement devices having lower priority when the voltage provided by the power supply is under a threshold level. When the voltage returns to operational levels (e.g., greater than the threshold level), the controller can resume or restart the distance measurement devices.

In some embodiments, the controller can determine an operational status for the distance measurement devices. The controller can monitor or measure currents/power consumptions at various ports/connections to determine the operational status. For example, the controller can determine the operational status to indicate that a motor is nearing the end of its operating life when current levels at the corresponding port/connection exceeds a predetermined threshold. In response to the determination, the controller can communicate alerts to an operator (e.g., via a user interface) so that remedial actions may be taken.

Some embodiments provide that the system is configured to assist installation of one or more of the plurality of distance measurement devices (e.g., the LIDAR sensors). The system can detect individual installation locations of individual distance measurement devices that are installed on the mobile platform at a plurality of different respective installation locations, detect corresponding individual installation statuses of the individual distance measurement devices, wherein an individual installation status is representative of whether the corresponding distance measurement device is properly installed on the mobile platform, and/or display the installation locations and the installation statuses for the distance measurement devices via a graphical user interface. In some cases, the system can assist installation of the LIDAR sensors at predefined locations on a mounting bracket attached to the mobile platform or directly on the mobile platform. In some cases, the system can assist custom installation (e.g. at user-defined locations on the mounting bracket and/or the body of the mobile platform) of the LIDAR sensors. The system can detect the installation locations based on user input, self-calibration data, a change in the location/orientation, or a combination thereof. Based on the installation, the system can detect the installation statuses based on self-test data received from the distance measurement devices. In some cases, the GUI can be used to display a plurality of visual elements representing a corresponding plurality of installation locations on the mobile platform. Each visual element can include one or more indicators showing that: (1) a distance measurement device at the corresponding installation location is properly installed, (2) a distance measurement device at the corresponding installation location is improperly installed, or (3) there is no distance measurement device installed at the corresponding installation location. The controller can be configured to send a control signal to at least one distance measurement device, wherein the control signal causes the at least one distance measurement device to output a notification (e.g., a visual notification, an audio notification, and/or a haptic notification) based on the installation status of the at least one distance measurement device.

In one or more embodiments, the system can be configured to perform a self-calibration process that produces a plurality of calibration parameters (e.g., position information and orientation information for individual distance measurement devices) for the plurality of distance measurement devices. The calibration parameters can be calculated based on observing a known environment around the mobile platform (e.g., such as by moving the mobile platform to a plurality of predefined positions), obtaining a corresponding plurality of calibration data sets from the plurality of distance measurement devices, calculating a combined calibration data set based on the plurality of calibration data sets, and/or determining the plurality of calibration parameters based on the combined calibration data set. Once calculated, the calibration parameters can be used to convert the plurality of distance measurement data sets into the single coordinate reference frame based on the plurality of calibration parameters.

Still a further embodiment includes a method of manufacturing any and all combinations of the devices described above. A different embodiment includes a method (e.g., including instructions stored in memory and executable by one or more processors) of operating the system or any and all combinations of the devices/portions therein as described above.

### BRIEF DESCRIPTION OF THE DRAWINGS

FIG. 1 is an illustration of a representative system having elements arranged in accordance with one or more embodiments of the present technology.

FIG. 2 is a functional block diagram of a controller configured in accordance with one or more embodiments of the present technology.

FIG. 3 is a block diagram a data link of a controller configured in accordance with an embodiment of the present technology.

FIG. 4 is a flow diagram for a managing operation of a distributed sensing system arranged in accordance with an embodiment of the present technology.

FIG. 5 is an illustration of a graphic user interface configured in accordance with an embodiment of the present technology.

FIG. 6 is a flow diagram for a process for calibrating the distributed sensing system arranged in accordance with an embodiment of the present technology.

FIG. 7 is a flow diagram for a calibration process for the distributed sensing system in accordance with an embodiment of the present technology.

### DETAILED DESCRIPTION

It is important for autonomous vehicles (e.g., fully autonomous vehicles or partially autonomous vehicles with computer-assisted maneuvering features) to be able to independently detect obstacles and/or to automatically engage in evasive maneuvers. Light detection and ranging (LIDAR) is a reliable and stable detection technology because LIDAR can remain functional under nearly all weather conditions. Moreover, unlike traditional image sensors (e.g., cameras) that can only sense the surroundings in two dimensions, LIDAR can obtain three-dimensional information by detecting the depth or distance, and/or reflectivity of an object. To facilitate the discussion hereafter, the basic working principle of an example type of LIDAR can be understood as follows: first, a LIDAR system emits a light signal (e.g., a pulsed laser); then, the LIDAR system detects the reflected light signal, measures the time passed between when the light is emitted and when the reflected light is detected, and calculates a distance of the reflecting object according to the time difference. The distance to a surrounding object can be calculated based on the time difference and the estimated speed of light, for example, “distance=(speed of light×time of flight)/2.” With additional information such as the angle of the emitted light, three-dimensional information of the surroundings can be obtained by the LIDAR system. In some embodiments, the LIDAR system can measure the reflectivity of an object, identify the material of the object, and/or initially identify the object (e.g., as people, vehicles, lane markers, trees, and/or other objects that exists in the vehicle's surrounding environment).

Traditional LIDAR systems typically include a rotary emitter and/or transmitter that is placed on top (e.g., on the roof) of the vehicle. For a wider measurement range and a more comprehensive measurement angle, the rotary emitter/transmitter is placed or raised high above the vehicle. Such a configuration often negatively affects the appearance of the vehicle, and/or maneuverability due to the raised center of gravity for the vehicle.

Accordingly, the present technology is directed to techniques for implementing a distributed sensor system (e.g., a distributed LIDAR system) to realize the perception of the external environment. Instead of one central sensor (e.g., the rotary emitter and/or transmitter) that scans a continuous region around the vehicle (e.g., up to 360° surrounding the vehicle), the distributed LIDAR system can include a set of multiple LIDAR scanners, each having a smaller/limited scanning range, that are set up to combine to scan the continuous region around the vehicle. The distributed LIDAR scanners can be installed around the vehicle (e.g. embedded in the vehicle's outer casing or installed using an attachable frame or mount), thereby eliminating the elevated central scanner while still providing a wide measurement range and comprehensive measurement angle.

To operate the set of separate sensors as a singular unit, the distributed sensor system can include a central management system (e.g., a controller including a data processing circuit, such as one or more processors) configured to unify the data interface across the set of sensors, coordinate operations and/or settings of the separate sensors, and/or provide other functions. For example, the central management system can be configured to summarize the sensor data from the distributed sensors, such as that the external interface can see the summarized sensor data from the central management system as an output from a singular LIDAR device. Accordingly, the central management system can perform sensor output conversion, coordinate point cloud calculation, and/or stitching to summarize the sensor data. As another example, the central management system can be configured to provide power management of the distributed LIDAR sensors, such as by providing power-on and power-off control, short-circuit prevention, fault detection, and/or operating mode management. In some embodiments, the central management system can be configured to detect installation, position, orientation, and/or other physical characteristics of the sensors relative to the vehicle. In some embodiments, the central management system can be configured to calibrate the sensors. Based on the central management system, other consumer systems/devices of the vehicle (e.g., the onboard computer, maneuvering system, and/or vehicle power management system) can interact with the distributed LIDAR sensors in the same way as other centralized LIDAR systems.

In the following description, the example of an autonomous vehicle is used, for illustrative purposes only, to explain various techniques that can be implemented using a distributed LIDAR system that is smaller and lighter than traditional LIDARs. In other embodiments the techniques described here are applicable to other suitable scanning modules, vehicles, or both. For example, even though one or more figures described in connection with the techniques illustrate a passenger automobile, in other embodiments, the techniques are applicable in a similar manner to other type of movable objects including, but not limited to, a UAV, a hand-held device, or a robot. In another example, even though the techniques are particularly applicable to a LIDAR system, other types of distance measuring sensors (e.g., radars and/or sensors using other types of lasers or light emitting diodes (LEDs)) can be applicable in other embodiments.

In the following, numerous specific details are set forth to provide a thorough understanding of the presently disclosed technology. In other embodiments, the techniques introduced here can be practiced without these specific details. In other instances, well-known features, such as specific fabrication techniques, are not described in detail in order to avoid unnecessarily obscuring the present disclosure. References in this description to “an embodiment,” “one embodiment,” or the like, mean that a particular feature, structure, material, or characteristic being described is included in at least one embodiment of the present disclosure. Thus, the appearances of such phrases in this specification do not necessarily all refer to the same embodiment. On the other hand, such references are not necessarily mutually exclusive either. Furthermore, the particular features, structures, materials, or characteristics can be combined in any suitable manner in one or more embodiments. It is to be understood that the various embodiments shown in the figures are merely illustrative representations and are not necessarily drawn to scale.

Several details describing structures or processes that are well-known and often associated with autonomous vehicles and corresponding systems and subsystems, but that can unnecessarily obscure some significant aspects of the disclosed techniques, are not set forth in the following description for purposes of clarity. Moreover, although the following disclosure sets forth several embodiments of different aspects of the present technology, several other embodiments can have different configurations or different components than those described in this section. Accordingly, the disclosed techniques can have other embodiments with additional elements or without several of the elements described below.

Many embodiments of the present disclosure described below can take the form of computer- or controller-executable instructions, including routines executed by a programmable computer or controller. Those skilled in the relevant art will appreciate that the disclosed techniques can be practiced on computer or controller systems other than those shown and described below. The techniques described herein can be embodied in a special-purpose computer or data processor that is specifically programmed, configured or constructed to perform one or more of the computer-executable instructions described below. Accordingly, the terms “computer” and “controller” as generally used herein refer to any data processor and can include Internet appliances and handheld devices (including palm-top computers, wearable computers, cellular or mobile phones, multi-processor systems, processor-based or programmable consumer electronics, network computers, mini computers and the like). Information handled by these computers and controllers can be presented at any suitable display medium, including a liquid crystal display (LCD). Instructions for performing computer- or controller-executable tasks can be stored in or on any suitable computer-readable medium, including hardware, firmware or a combination of hardware and firmware. Instructions can be contained in any suitable memory device, including, for example, a flash drive, USB device, and/or other suitable medium.

The terms “coupled” and “connected,” along with their derivatives, can be used herein to describe structural relationships between components. It should be understood that these terms are not intended as synonyms for each other. Rather, in particular embodiments, “connected” can be used to indicate that two or more elements are in direct contact with each other. Unless otherwise made apparent in the context, the term “coupled” can be used to indicate that two or more elements are in either direct or indirect (with other intervening elements between them) contact with each other, or that the two or more elements co-operate or interact with each other (e.g., as in a cause and effect relationship), or both.

For purposes of discussion herein, the terms “horizontal,” “horizontally,” “vertical,” or “vertically,” are used in a relative sense, and more specifically, in relation to the main body of the unmanned vehicle. For example, a “horizontal” scan means a scan having a scan plane that is generally parallel to the plane formed by the main body, while a “vertical” scan means a scan having a scan plane that is generally perpendicular to the plane formed by the main body.

### 1. Overview

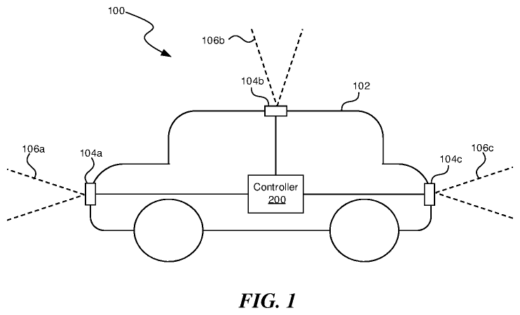

FIG. 1 is an illustration of a representative system 100 having elements arranged in accordance with one or more embodiments of the present technology. The system 100 includes a mobile platform 102 (e.g., an autonomous or a semi-autonomous vehicle, including a self-driving car, a UAV, and/or other autonomously mobile device) that has a set of sensors 104a-104c (e.g., LIDAR devices with limited scanning ranges) attached or imbedded thereon. The sensors 104a-104c can include LIDAR emitters and/or receivers configured to detect locations of objects and/or surfaces in the environment surrounding the mobile platform 102. The sensors 104a-104c can have a corresponding field of view 106a-106c that covers a unique region around the mobile platform 102. Each of the sensors 104a-104c can have the field of view that is limited and less than 360°. Based on different placements and orientations of the sensors 104a-104c, even with the limited fields of view 106a-106c, the set of sensors 104a-104c can provide a comprehensive scan (e.g., a continuous field of view, including a full 360° scan, or select predetermined regions) around the mobile platform 102. In some embodiments, the fields of view 106a-106c can overlap.

The representative system 100 can include a controller 200 operatively coupled to the sensors 104a-104c. The controller 200 (e.g., a circuit including one or more processors, a printed circuit board (PCB), and/or digital/analog components) can be configured to function as a central management system that manages operations of the set of sensors 104a-104c. For example, the controller 200 can be configured to unify the data interface across the set of sensors and/or coordinate operations and/or settings of the separate sensors. The controller 200 can summarize the sensor output form the sensors 104a-104c, provide power management for the sensors 104a-104c, and/or other management functions for the sensors 104a-104c. In some embodiments, the controller 200 can be configured to detect installation, position, orientation, and/or other physical characteristics of the sensors 104a-104c relative to the mobile platform 102. In one or more embodiments, the controller 200 can be configured to calibrate the sensors 104a-104c.

### 2. A Distributed Sensor/LIDAR Management System

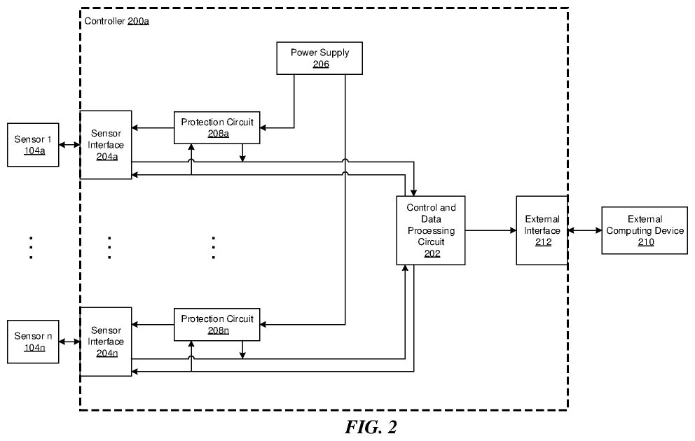

FIG. 2 is a functional block diagram of a controller 200a (e.g., the controller 200 of FIG. 1) configured to manage a set of distributed sensors in accordance with one or more embodiments of the present technology. The controller 200a can be operatively coupled to a set of n sensors 104a-104n (e.g., similar to the sensors 104a-104c of FIG. 1) located around the mobile platform 102 of FIG. 1), and/or an external computing device 210 (e.g., one or more subsystems for the mobile platform 102 that interacts with the sensors 104a-104n).

For example, the controller 200a can include a set of sensor interfaces 204a-204n that are each configured to communicate with the set of sensors 104a-104n. The sensor interfaces 204a-204n can be configured to communicate sensor data and adjustments, control information, and/or status information between the controller 200a and the sensors 104a-104n. The sensor interfaces 204a-204n can further provide power from a power supply 206 to the sensors 104a-104n. As another example, the controller 200a can include an external interface 212 that is configured to communicate with a vehicle power management system, an autonomous maneuvering system, and/or other functional subsystem of the mobile platform 102. The external interface 212 can communicate status information, commands, sensor information, the combined sensor output, and/or other sensor-related information between the controller 200a and the external computing device 210.

In interacting with the set of sensors 104a-104n, the controller 200a can be configured to manage power supplied to the sensors 104a-104n. For example, the controller 200a can include a control and data processing circuit 202 (e.g., one or more processors) configured to control a set of protection circuits 208a-208n that connect the power supply 206 to the sensor interfaces 204a-204n. The protection circuits 208a-208n and/or the sensor interfaces 204a-204n can include one or more detection circuits (e.g., sensors) configured to measure voltage, current, power, and/or other energy-related parameters being supplied to the corresponding sensor interface. The control and data processing circuit 202 can receive the measurement (e.g., current readings) from the protection circuits 208a-208n and compare the value to one or more threshold values. When the measurement is outside an operating level or range defined by the threshold values, the control and data processing circuit 202 can send a break command to the corresponding protection circuit and/or the sensor interface. In some embodiments, the protection circuits 208a-208n and/or the sensor interfaces 204a-204n can each include a power switch that can open based on the break command. In some embodiments, the break command can be communicated to the corresponding sensor, which can enter a standby mode or an off mode based on the break command. Accordingly, the control and data processing circuit 202 can control the power connection to protect the sensor and/or the overall system from burning out in some scenarios. In some embodiments, the controller 200a can include current-limiting chips, fuses or breakers, and/or other protection circuits/components in the protection circuits 208a-208n for providing the power control.

In some embodiments, the control and data processing circuit 202 can be configured to restart one or more of the sensors 104a-104n, such as by issuing a restart command or by cycling the power. In some embodiments, the control and data processing circuit 202 can be configured to manage system startup, such as by staggering the startup operations of the sensors 104a-104n. When the sensors are powered up, the supply current may be larger (e.g., transient spikes) than at other times. When the power is turned on, the capacitor on the power link can charge and the current can increase. As such, to reduce the maximum current draw for the system, the control and data processing circuit 202 can sequentially power up the sensors 104a-104n instead of performing a simultaneous power up.

Further, the controller 200a can be configured to manage functions of the sensors 104a-104n. For example, the control and data processing circuit 202 can be configured to determine and control operating states/modes of the sensors 104a-104n. In some embodiments, the control and data processing circuit 202 can send status query commands to the sensors 104a-104n, and then receive and track the status replies (e.g., for operating modes and/or failure or error status) for each of the sensors 104a-104n.

In some embodiments, the control and data processing circuit 202 can determine the operating mode of the sensors 104a-104n based on the current draw reading. For example, the sensors can draw minimal current in sleep or standby mode. Further, the sensors can operate in different performance modes (e.g., high or maximum performance mode, low or minimum performance mode, and/or one or more balanced or intermediate performance modes) that draw directly proportionate amounts of current. Accordingly, to determine the operating modes of the sensors, the control and data processing circuit 202 can compare the current draw readings to threshold ranges that are characteristic of different operating modes.

Various use cases and applications can be realized or implemented based on the control and data processing circuit 202 controlling multiple sensors 104a-104n. For example, different performance modes (e.g., a high-speed driving mode, a low-speed driving mode, a highway navigation mode, etc.) can be associated with different quantities/combinations of settings for the sensors 104a-104n. Each performance mode can be associated with specific settings (e.g., on/off status, sampling rates, etc.) for the sensors 104a-104n according to their sensing directions. Accordingly, the control and data processing circuit 202 can balance power consumption, noise, and detection results according to the context associated with the performance modes.

Further, the controller 200a can be configured to control or adjust the operating modes according to context (e.g., different operating conditions or status, the operating environment, and/or other circumstance/situation associated with the vehicle/environment) of the mobile platform 102. For example, similar to the operating modes, the control and data processing circuit 202 can determine (e.g., via a regularly occurring query and receive, through an open data stream, and/or other suitable techniques) an operating state or condition of the mobile platform 102 and/or the surrounding environment. The control and data processing circuit 202 can determine current speed, current maneuver, brake or gear state, current location, remaining system power, and/or other operating state or condition of the vehicle. Further, the control and data processing circuit 202 can determine road conditions, type of road being traversed, and/or other information associated with the surrounding environment. The control and data processing circuit 202 can adjust the operating modes of one or more of the sensors 104a-104n based on the operating state or condition of the mobile platform 102.

In some embodiments, the control and data processing circuit 202 can set the operating modes of the sensors 104a-104n to sleep/standby mode when the vehicle is running but not in gear, speed reading is zero, and/or other characteristic of the vehicle being in a parked state. The control and data processing circuit 202 can command the sensors 104a-104n to enter active scanning mode when the vehicle is in gear, route or destination is received, and/or other indications that the vehicle is or will move. Similarly, the control and data processing circuit 202 can adjust the operating mode to increase the performance as the vehicle speed increases (e.g., based on comparing the vehicle speed to speed-based triggers). In some cases, the control and data processing circuit 202 can adjust the operating mode to increase the performance based on a determination or an indication from the vehicle that represents a presence of pedestrians or an increase thereof, such as during peak commute hours, popular locations, and/or other indicators associated with the number of pedestrians. In some embodiments, the control and data processing circuit 202 can adjust the operating mode according to other information or indications associated with location (e.g., lower required performance when the vehicle is stopped at a stop light than when the vehicle is in more complex environments, such as school zones or busy intersections), time (e.g., lunch hour and peak commute times requiring increased performance), recognized context (e.g., approaching construction zones, and/or detecting an accident ahead).

In some embodiments, the control and data processing circuit 202 can adjust the operating mode according to a maneuver being performed by the vehicle. For example, the control and data processing circuit 202 can increase the performance of the forward-facing sensors and the back-ward facing sensors that match the direction of travel. In another example, the control and data processing circuit 202 can increase the performance of the side or diagonally facing sensors that correspond to an upcoming turn.

In some embodiments, the control and data processing circuit 202 can temporarily increase the performance when the sensor output matches known objects, such as for pedestrians or other vehicles, within a threshold distance. In some embodiments, the control and data processing circuit 202 can temporarily increase the performance when the sensor output indicates an object within a threshold distance.

In some embodiments, the control and data processing circuit 202 can adjust the operating modes to manage power consumption. For example, the control and data processing circuit 202 can command the sensors to operate in an appropriate intermediate mode when the vehicle data or condition does not indicate any extreme conditions. As another example, the control and data processing circuit 202 can reduce the sensor performance (e.g., as part of a set of vehicle adjustments) when the system power is below a threshold level.

Further, in some embodiments, the controller 200a can be configured to further perform power management for the sensors 104a-104n according to the vehicle data. For example, the control and data processing circuit 202 can control the power state (e.g., sensor on/off, active mode or standby/sleep mode, and/or other operating modes) of the sensors 104a-104n according to the vehicle on/off state, parking or gear status, and/or other contextual determination. When the control and data processing circuit 202 determines that the mobile platform 102 is off, parked, and/or other contextual indicators., the control and data processing circuit 202 can disconnect the power connection, command the sensors to enter standby/sleep mode, and/or perform other associated actions.

In interacting with the external computing device 210, the controller 200a can be configured to combine or summarize the sensor data from the set of separate sensors 104a-104n. In some embodiments, the control and data processing circuit 202 can include a data summary circuit therein configured to summarize the LIDAR data and send it out through the external interface 212. For example, the data summary circuit can be configured to generate a combined point cloud based on combining the separate point clouds that each correspond to a LIDAR sensor. Accordingly, the data summary circuit can provide a singular set of LIDAR data, such as from a single rotating LIDAR system. Based on the data summary circuit, the mobile platform 102 can interact with the distributed sensor system same as it would interact with a single rotating LIDAR system without any adjustments in protocol, hardware, software, etc.

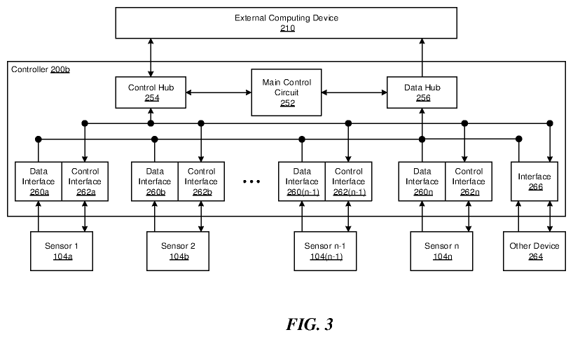

FIG. 3 is a block diagram a data link of a controller 200b (e.g., the controller 200 of FIG. 1) configured in accordance with an embodiment of the present technology. The controller 200b can include a main control circuit 252 configured to control the communication between the controller 200b and the sensors 104a-104n, the external computing device 210, etc. For example, the main control circuit 252 (e.g., a circuit within or connected to the control and data processing circuit 202 of FIG. 2) can be configured to control connection and data communication, including collecting data from connected sensors. In some embodiments, the main control circuit 252 can be configured to control connections to other scalable devices, such as GPS, IMU, etc.

The main control circuit 252 can be operably coupled to a control hub 254, a data hub 256, etc. The control hub 254 can include circuit configured to communicate control signals, commands, statuses, replies, etc. with the external computing device 210 and/or the sensors 104a-104n. The data hub 256 can include circuit configured to communicate data with the sensors 104a-104n, the external computing device 210, etc. The hubs (e.g., the control hub 254, the data hub 256, etc.) can be configured to identify a designated target for control commands from the external computing device 210 and/or the main control circuit 252. Based on the identification of the target, the hubs can assign or route the control commands to the designated target.

The controller 200b can be operably coupled to each of the sensors 104a-104n through a separate interface (e.g., data interfaces 260a-260n and/or control interfaces 262a-262n), such that each sensor is independent (e.g., for minimizing interference across sensors and ensuring stable data bandwidth). For example, the control hub 254 can be operably coupled to the control interfaces 262a-262n, and the data hub 256 can be operably coupled to the data interfaces 260a-260n. The data interfaces 260a-260n can be part of the sensor interfaces 204a-204n of FIG. 2 that are configured to communicate data to/from the corresponding sensors. The control interfaces 262a-262n can be part of the sensor interfaces 204a-204n that are configured to communicate controls, commands, status, replies, etc. to/from the corresponding sensors.

The data link can include wired connections (e.g., Ethernet connections, wire buses, twisted pairs, etc.) or wireless connections (e.g., WIFI, Bluetooth, etc.) between the components (e.g., within the controller 200b, between the controller 200b, the external computing device 210, and/or the sensors 104a-104n, etc.). The data link can be based on one or more communication architectures or protocols, such as IP protocols, Ethernet protocols, etc. In some embodiments, the controller 200b can be connected to the sensors 104a-104n via Ethernet. The controller 200b can accordingly assign IP addresses to each of the sensors 104a-104n, establishing/maintaining a connection with each of the sensors 104a-104n, etc. The devices (e.g., the controller 200b or portions therein, the sensors 104a-104n, etc.) can send and receive network packets for communicating commands, statuses, payload data (e.g., sensor outputs), etc.

For example, the controller 200b (e.g., a main control circuit 252, a control hub 254, a data hub 256, etc. therein) can establish a connection with the sensors 104a-104n based on initially dynamically assigning an IP address to each of the sensors 104a-104n based on different hardware interfaces. Once the IP addresses are assigned, the controller 200b can obtain (e.g., via a query or an identify command) from the sensors a basic or initial set of information, such as a serial number, hardware version and/or identifier, firmware version and/or identifier, and/or other identifiers. The controller 200b can further send to the sensors control information, such as the IP address, the data port, and/or the control port of the controller 200b. The controller 200b can obtain (e.g., via an open data stream or a periodic query) sensor output data from the sensors through the data ports (e.g., the data interfaces 260a-260n). The controller 200b can obtain status information (e.g., temperatures, working mode, error code, etc.) through the control ports (e.g., the control interfaces 262a-262n). The controller 200b can further maintain the connections to the sensors by heartbeat package (e.g., a common clock or timing signal).

As illustrated in FIG. 3 and described above, the controller 200b can assign an IP address and a port number to each of the sensors 104a-104n according to the hardware interface without any switch/router for connecting the respective sensors. Information such as SN code can be automatically acquired during communication, and each hardware port need not be bound to a specific LIDAR sensor, such that different devices can be completely replaced.

In some embodiments, the controller 200b can establish an Ethernet connection with the external computing device 210 (e.g., a host computer). The controller 200b can apply for an IP address, and the DHCP server in the network can assign an IP address to the controller 200b. The controller 200b can broadcast the SN code after the IP address assignment. After receiving the broadcast, the external computing device 210 (e.g., the host computer) can reply to the IP address, control port and data port of the external computing device 210. The controller 200b can send a combined sensor data (e.g., the point cloud data) of the set of sensors 104a-104n to the external computing device 210. The controller 200b can further respond to the control request sent by the external computing device 210 in real-time. In sending the combined sensor data, the controller 200b (e.g., the main control circuit 252, the control and data processing circuit 202 of FIG. 2, the data hub 256, etc.) can acquire the LIDAR data packet or the point cloud data from each sensor. In combining the sensor outputs, the data sent by each sensor can be summarized based on data aggregation, buffering, processing, recombining, forward, etc. The controller 200b can perform data fusion based on coordinate transformation, synchronous time stamp conversion, etc.

In some embodiments, the controller 200b can request status data from each sensor while acquiring the point cloud. The controller 200b can analyze the status data to obtain the working status of each sensor. During the operation, when a certain sensor has an abnormal working state, the controller 200b can implement a forced restart (e.g., via a reset command, power cycling, etc.) to repair the erroneous working state of the sensor. When an abnormal working state of a certain sensor cannot be eliminated, the controller 200b can change the scanning mode, scanning frequency, etc. of one or more sensors, thereby improving the working frequency of the other working sensors to offset the adverse effects of the problematic sensor.

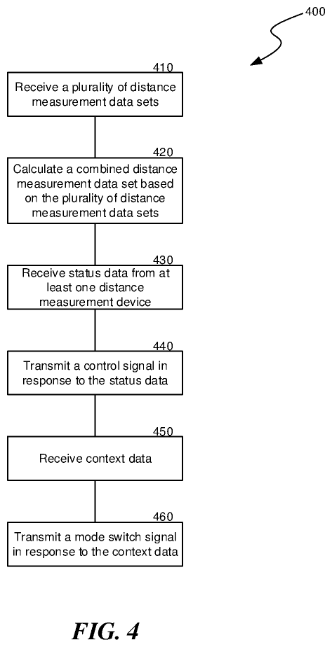

As an example of the data processing and/or the status analysis, FIG. 4 is a flow diagram for a managing operation 400 of a distributed sensing system arranged in accordance with an embodiment of the present technology. FIG. 4 can illustrate an example method for detecting an environment around a mobile platform. The managing operation 400 can be for operating the controller 200 of FIG. 1 (e.g., the controller 200a of FIG. 2, the controller 200b of FIG. 3, etc.) or one or more components therein in controlling the sensors 104a-104n of FIG. 2, interacting with the external computing device 210 of FIG. 2, etc.

At block 410, the controller 200 can receive a plurality of distance measurement data sets from the set of sensors 104a-104n. In some embodiments, each of the sensors 104a-104n can continuously output the sensor data to the controller 200, such as through an open data stream. In some embodiments, each of the sensors 104a-104n can periodically output the sensor data to the controller 200 without any prompts from other devices. In some embodiments, the controller 200 can periodically send queries or report commands that prompt the sensors 104a-104n to report the sensor data. The output sensor data can be communicated through the corresponding data interfaces, the data hub 256, the data link connecting the components, and/or any other components.

At block 420, the controller 200 (e.g., the data hub 256, the main control circuit 252, the control and data processing circuit 202, etc.) can calculate a combined distance measurement data set based on the plurality of distance measurement data sets. The controller 200 can combine the separate point clouds output by each sensor based on regions or directions relative to the mobile platform 102 of FIG. 1. In other words, the controller 200 can combine the point clouds such that the combined distance measurement data set represents multiple separate regions or a continuous environment/space around the vehicle. For example, the controller 200 can determine a universal coordinate system (e.g., a single coordinate reference frame) that charts the space surrounding the mobile platform 102. The controller 200 can further identify reference locations or directions for each of the sensors. The controller 200 can calculate a transfer function for each sensor that maps or translates the reference locations/direction of each sensor (and thereby the sensor's own coordinate reference frame) to the universal coordinate system or the universal map. The controller 200 can apply the transfer function to each of the point cloud from the sensors for a given time frame (e.g., synchronous time stamp conversion) and combine the translated results to calculate the combined distance measurement data set (e.g., the combined point cloud). At a separate step (not shown), the controller 200 can send the combined distance measurement data set to the external computing device 210.

At block 430, the controller 200 can receive status data from at least one distance measurement device (e.g., one or more of the sensors 104a-104n). In some embodiments, the sensors can be configured to report the status information in connection (e.g., simultaneously on a different data link, offset by a duration before or after, etc.) with the sensor output data. In some embodiments, the sensors can be configured to periodically send the status information without any prompts. In some embodiments, the controller 200 can be configured to issue a query or a command that prompts one or more of the sensors to report the status information.

At block 440, the controller 200 (e.g., the data hub 256, the main control circuit 252, the control and data processing circuit 202, etc.) can transmit a control signal in response to the status data. The controller 200 can analyze the received status information for any abnormalities, such as unexpected operating mode, an error code, a temperature reading exceeding a predetermined threshold, a current reading exceeding a threshold, etc. The controller 200 can be configured (e.g., via switch cases, artificial intelligence, and/or other hardware/software mechanism) to issue a command that matches the status information. For example, the controller 200 can initiate a forced reset when a sensor reports an abnormality. As another example, the controller 200 can break the power connection when a corresponding sensor reports a temperature and/or a current draw that exceeds a threshold condition.

In some embodiments, the controller 200 can change a performance level of one or more sensors, such as by adjusting the operating mode (e.g., among high performance mode, low performance mode, one or more intermediate performance modes, and/or any other modes), sampling parameters (e.g., sampling frequency, sampling interval, and/or other parameters), etc., when an adjacent sensor reports an abnormality. For example, the different levels of performance can be based on signal/pulse power or magnitude, pulse rate, pulse frequency, maximum measurable distance, output density, filter complexity, etc. Accordingly, the higher performance modes can provide increased accuracy or reliability, increased measurement range, additional processing outputs (e.g., determination of reflectivity, preliminary identification of the object, etc.), additional measurements or data points within the point cloud, etc. in comparison to the lower performance modes. Further, in providing the improved outputs and measurements, the higher performance modes can consume more power or require more processing resources in comparison to the lower performance modes.

At block 450, the controller 200 can receive context data, such as status/condition of the mobile platform 102 or a portion thereof, an upcoming or current maneuver performed by the mobile platform 102, a location or an indication/code associated with the vehicle location, an indication/code associated with a condition occurring/existing in the space surrounding the vehicle, etc. In some embodiments, the controller 200 can receive the context data from the external computing device 210 through an open data stream. In some embodiments, the controller 200 can receive the context data based on a regularly provided communication (i.e., without prompting or querying the external computing device 210). In some embodiments, the controller 200 can be configured to periodically prompt the external computing device 210 for the context data.

At block 460, the controller 200 can transmit a mode switch signal in response to the context data. The controller 200 can adjust the operating mode of one or more sensors 104a-104n according to the received context data. In some embodiments, the controller 200 can send signals based on vehicle status. For example, the controller 200 can send signals to increase performance on a first subset of sensors (e.g., forward-facing sensors) and/or to decrease performance on a second subset of sensors (e.g., rear-facing sensors) when forward-moving gears are engaged, and vice versa when rearward-moving gears are engaged. As another example, the controller 200 can increase or decrease the sensor performance based on vehicle speed and/or application of the brakes.

In some embodiments, the controller 200 can adjust the operating mode based on route and/or maneuver information. For example, the controller 200 can receive indications that a turn is upcoming within a threshold amount of time or distance. Based on the upcoming maneuver (e.g., left or right turn, a lane change, etc.), the controller 200 can increase the sensor performance for a subset of sensors (e.g., left or right facing sensors for the corresponding turn, blind-spot sensors and/or side sensors for the lane change, etc.) that correspond to the upcoming maneuver.

In some embodiments, the controller 200 can adjust the operating mode based on a location-based indication. For example, the controller 200 can receive an indication or a code from a subsystem (e.g., routing system, autonomous driving system, etc.) in the vehicle that the vehicle is stopped at a parking lot or a stop light, passing through a school zone or a pedestrian-heavy region (e.g., shopping areas or tourist locations), a construction zone, and/or other contextually-relevant locations. The controller 200 can decrease the performance or command standby mode for one or more sensors when the vehicle is stopped at a parking lot or a stop light. The controller 200 can increase the performance of one or more sensors when the vehicle is in a school zone, a pedestrian-heavy region, a construction zone, etc. The controller 200 and/or the vehicle subsystem can account for the current time, historical data, etc. in generating or responding to the location-based indications.

In some embodiments, the controller 200 can adjust the operating mode based on a visual signal or an initial analysis of the separate point cloud data. For example, the controller 200 can increase the performance of a sensor when the point cloud data for the sensor (e.g., as analyzed at the data hub) represents an object within a threshold distance from the vehicle, or a rate of change in the distance of the object that exceeds a threshold. In other examples, the controller 200 can increase the performance when it receives an indication from a visual-data processing system that a certain object (e.g., a particular road sign, such as a construction or a caution road sign, a pedestrian, etc.).

### 3. A Distributed Sensor/LIDAR Initiation System

In some embodiments, the controller 200 of FIG. 2 can include an application software toolkit configured to assist the operator in installing/checking/troubleshooting and/or otherwise supporting the set of sensors 104a-104n. For example, the software tools can include a visual user-interaction function (e.g., the GUI 500), a system configuration function, a status detection/display function, a mode definition/switching function, an assisted installation function, a self-test function, a self-calibration function, and/or another suitable function.

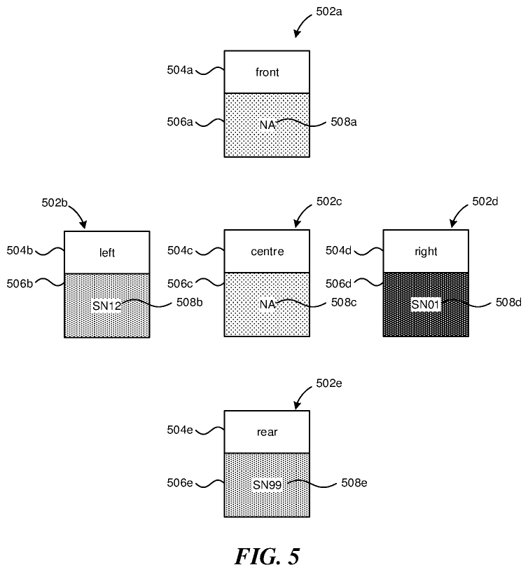

FIG. 5 is an illustration of a graphic user interface (GUI) 500 configured in accordance with an embodiment of the present technology. The GUI 500 can be configured to provide visual interaction with an operator (e.g., an operator/driver, a manufacturer or an installer, a trouble-shooting technician, etc. of the mobile platform 102 of FIG. 1). The GUI 500 can further allow the user to select and implement one or more of the tools/functions.

In some embodiments, the GUI 500 can be configured to communicate information associated with installing the sensors or LIDARs (e.g., for one or more of the sensors 104a-104n of FIG. 2). In some embodiments, the GUI 500 can communicate location, status, identity, etc. of the sensors or LIDARs installed on or around the mobile platform 102. For example, the GUI 500 can display and/or receive installation-status 502a-502e, location indicators 504a-504e, status indicators 506a-506e, identification information 508a-508e, etc. The installation-status 502a-502e, as illustrated by presence or absence of other parameters (e.g., the status indicators 506a-506e, the identification information 508a-508e, etc.), can represent whether or not a sensor is installed or detected at a specific location. The location indicators 504a-504e can represent a description of the location and/or orientation of the corresponding sensor relative to the mobile platform 102. The status indicators 506a-506e can display different colors (represented by shading in FIG. 5) to indicate the operating modes and/or reported status (e.g., error, delayed reply, etc.) of the corresponding sensors. The identification information 508a-508e can include an IP address, a part or a serial number, etc. that identifies the corresponding sensor/LIDAR device.

In some embodiments, the GUI 500 can assist the operator install (e.g., attached directly to the vehicle body/chassis or on a known mounting bracket, user defined installation or locations, etc.) and operably couple the sensors to the mobile platform 120. For example, the sensors can be installed at known or predetermined locations, such as according to a design specification for the vehicle or a pre-set mounting bracket. The GUI 500 can visually display the installation state of the sensor at each predefined installation position (e.g., at the locations of receptors or sensor mounts). If the user connects the sensor at a certain position, the controller 200 can interact with the connected sensor (e.g., via a registration process, such as by issuing an IP address and/or querying for identification information). The received identification information can be stored and further displayed according to the corresponding location indicator.

In some cases, one or more of the devices (e.g., the mount, an installation sensor, the installed sensor, etc.) can include functions to detect optimal installation state (e.g., with the location and/or the orientation of the sensor satisfying a threshold range thereof). The installation status can be communicated to the controller 200 and displayed using the GUI 500 as the status indicator. In some embodiments, the installation errors can be determined by the controller 200 and/or the sensors based on analyzing an initial point cloud from the sensor or a set of point clouds from a set of sensors (e.g., including sensors adjacent to the installed or targeted sensor). The analysis, similar to a calibration operation described below, can provide an error level and/or direction. The GUI 500 can display the error level and/or the direction through the status indicator such that the operator can adjust the placement and/or orientation of the corresponding sensor accordingly.

Instead of predetermined locations, the sensors can be installed at user-defined locations (e.g., custom locations) around the vehicle in some embodiments. In such cases, the GUI 500 can be configured to receive pre-installed parameters (e.g., a part number, device type, max/min range or other operating parameters, etc.) regarding one or more sensors. The application toolkit can suggest a location and/or an orientation for each of the sensors according to the pre-installed parameters. The operator can report an installation location of the sensors through the GUI 500, such as by agreeing with the suggestion or specifying the user's own location for a particular sensor. In some embodiments, the operator can install the sensors and provide a comprehensive description of the environment, e.g., based on manually rotating one or more sensors and/or placing known objects at specific locations around the vehicle. The application toolkit can match the point clouds from each of the sensors to portions of the comprehensive description to automatically determine the location/orientation of each of the sensors. After detecting the locations/orientations of the user-specified/located sensors, the tool kit can operate in a manner similar to that described above (e.g., displaying the identification information, the status, the determined location, etc. for the installed sensors through the GUI 500).

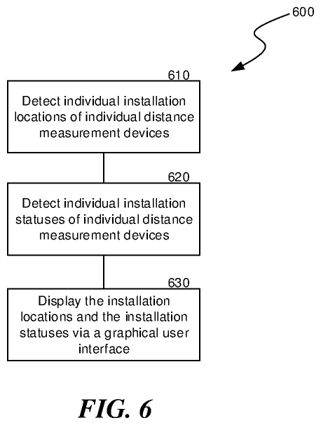

FIG. 6 is a flow diagram for a representative sensor installation process 600 for the distributed sensing system, arranged in accordance with an embodiment of the present technology. FIG. 6 illustrates an example method for assisting installation of an environmental detection system (e.g., distributed LIDAR system) for a mobile platform. The sensor installation process 600 can be for operating the controller 200 of FIG. 1, the controller 200a of FIG. 2, the controller 200b of FIG. 3, one or more components therein, or a combination thereof to assist in installing one or more sensors (e.g., one or more of the sensors 104a-104n of FIG. 2).

At block 610, the controller 200 and/or the toolkit can detect individual installation locations (e.g., the location indicators 504a-504e of FIG. 5 in relation to the identification information 508a-508e of FIG. 5) of individual distance measurement devices (e.g., the sensors 104a-104n, such as LIDAR devices). The installation locations can be detected based on one or more processes described above. For example, the controller 200 and/or the toolkit can interact with the operator, individual sensors, other sensory devices at the mount locations, etc. to detect installation of specific sensors at predetermined locations (e.g., according to vehicle specification or mounting rack configuration). Another example can include the controller 200 and/or the toolkit interacting with the operator, individual sensors, etc. to detect installation of specific sensors at user-defined or custom locations.

At block 620, the controller 200 and/or the toolkit can detect individual installation statuses (e.g., the status indicator 506a-506e of FIG. 5) of the individual distance measurement devices. For example, the controller 200 and/or the toolkit can prompt and/or receive a report from the installed sensor, the operator, other installation/mount sensors, etc. to detect its installation status. In a different example embodiment, the controller 200 and/or the toolkit can analyze a received point cloud from one or more of the sensors against a known template to detect the installation statuses of the one or more sensors.

At block 630, the controller 200 and/or the toolkit can display the installation locations and the installation statuses via a GUI (e.g., the GUI 500). The controller 200 and/or the toolkit can associate the sensor locations, the sensor identification, the installation status, etc. to generate and display the individual installation-status 502a-502e of FIG. 5 for each sensor.

### 4. System Test and Calibration

In some embodiments, the system 100 of FIG. 1 (e.g., the controller 200 of FIG. 1, the toolkit, the sensors 104a-104n of FIG. 2, etc.) can be configured to implement a self-test function and/or a calibration function. For the self-test function, the controller 200 or one or more components therein can perform the self-test to verify that the tested device itself is operating as intended. The self-test function can include implementing a self-test routine included in the system 100 (e.g., the controller 200, the toolkit, the sensors 104a-104n, etc.) to test the controller 200 and/or the sensors 104a-104n. The self-test function can further include displaying, such as through the GUI 500 of FIG. 5 or a different GUI, the self-test results (e.g., as the status indicator 506a-506e of FIG. 5) for an operator. The self-test function can be implemented for a first use of the product after leaving a manufacturing facility or at an installation facility. Additionally, operators (e.g., the vehicle owner or user) can initiate the self-tests at any time or set up regular self-test programs.

For the calibration function, the system 100 (e.g., the controller 200, the toolkit, the sensors 104a-104n, etc.) can regulate position and/or orientation of each sensor in the geodetic coordinate system. The calibration function can account for user's custom installations, and any changes to the sensor position/orientation that may occur during regular operation and movement of the mobile platform 102 of FIG. 1. The calibration function can include a self-calibration process based on data collected by the sensors 104a-104n, without using any detection device outside of the sensors/mobile platform. In some embodiments, the calibration function can implement two or more modes that include a multi-sensor self-calibration mode and a joint self-calibration mode associated with the sensor set and other vehicle sensors.

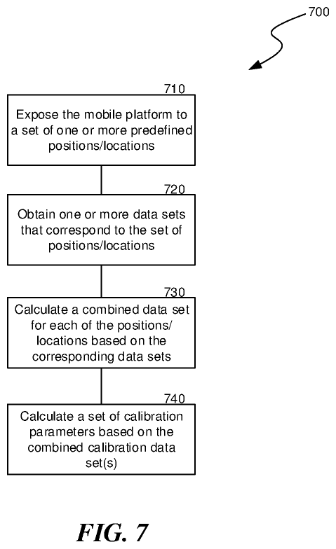

FIG. 7 is a flow diagram of a process 700 for calibrating the distributed sensing system in accordance with an embodiment of the present technology. FIG. 7 illustrates an example method of self-calibrating the sensors 104a-104n of FIG. 2 for the system 100 of FIG. 1 (e.g., for the mobile platform 102 of FIG. 1). The calibration process 700 can be implemented using the overall system 100 or one or more portions thereof (e.g., the controller 200 of FIG. 1, the external computing device 210 of FIG. 2, etc.).

At block 710, the system 100 can expose the mobile platform to a set of one or more predefined scenes, such as by moving the mobile platform through a sequence of positions/locations and/or by controlling the scene/environment around the mobile platform. The various scene exposures can be based on rotating/moving the mobile platform 102 and/or predetermined targets about one or more axes (e.g., according to six-axis movement) For example, the controller 200 and/or the external computing device (e.g., the autonomous driving system of the mobile platform 102) can cause the mobile platform 102 to traverse to a predetermined position/location or a sequence thereof, such as a predetermined calibration location or route. In some embodiments, the operator can place known objects at one or more predetermined locations relative to the mobile platform 102 to recreate the predefined positions/locations. As an example, the predefined position/location can include an open area of at least 20 meters by 20 meters. The predefined position/location can further include a set number (e.g., 10-20) of predefined objects. The objects can include, for example, 1 meter by 1 meter square calibration plates at specified locations within the predefined location/area. In other embodiments, the mobile platform 102 can be placed at a calibration facility that presents various known scenes or targets for the calibration.

At block 720, the system 100 can obtain one or more data sets that correspond to the set of positions/locations. For example, the controller 200 can obtain the sensor output from the sensors 104a-104n when the mobile platform 102 is located at the predefined location/area or as the mobile platform 102 is traversing through the predefined locations/positions. The mobile platform 102 can perform a predetermined set of maneuvers associated with the calibration process. In some embodiments, the predetermined set of maneuvers can include rotating the vehicle 360° through a set number of times. The controller 200 can collect the cloud points at certain intervals, after performing specific maneuvers, etc.

At block 730, the system 100 can calculate a combined data set for each of the positions/locations based on the corresponding data sets. For example, the controller 200 can collect or identify the point clouds that correspond to the same point stamp, and map them to a universal coordinate set. The controller 200 can combine the set of translated point clouds that correspond to the same time stamp into a single point cloud to generate the combined calibration data set for the corresponding time stamp.

At block 740, the system 100 can calculate a set of calibration parameters based on the combined calibration data set(s). For example, the controller 200 can perform the self-calibration process by calculating position and angle parameters of each sensor in the geodetic/universal coordinate system. After calculating the position and angle parameters, the controller 200 can store the calibration parameters for the fusion of point cloud data output from the multiple sensors. In some embodiments, the controller 200 and/or the toolkit can provide interfaces (e.g., through the GUI 500 of FIG. 5 or a different GUI) for operators to read the parameters (e.g., position and angle parameters) and/or modify the parameters.

In some embodiments, the system 100 can perform the joint-calibration process based on the sensor calibration process described above (e.g., the calibration process 700). For example, the joint-calibration process can include the mobile platform traversing to/through one or more predefined locations/positions as described above at block 710. Similar to the description above for block 720, the system 100 can obtain sensed output from the LIDAR sensors along with other sensors (e.g., one or more cameras, GPS circuit, IMU, etc.) at the locations/positions and/or while performing a set of predefined maneuvers thereat. Further, similar to the description above for blocks 730 and/or 740, the system 100 can process or combine the separate sensor outputs, calculate the position/orientation of each of the sensors, etc.

As compared to the single 360° LIDAR device discussed above, a distributed sensor system that includes multiple separate LIDAR devices improves the aesthetics of the vehicle. In some cases, the distributed sensor system can improve the performance and safety of the vehicle by reducing the length of any extensions associated with the LIDAR device. For example, the distributed sensor system can reduce or eliminate any structures on top of the vehicle's body (e.g., as often required to raise the single 360° LIDAR device), thereby lowering the vehicle center of gravity and improving the vehicle's stability, turning capacity, etc.

In using the distributed sensor system (which includes multiple different sensor devices), the controller (e.g., a management system for the distributed LIDAR system) can manage and control the set of sensors as one unit or device. As described above, the controller can be configured to manage the operations (e.g., power status, operating modes, etc.) of each sensor and combine the separate sensed outputs (e.g., individual point clouds) from each sensor into one combined sensed result (e.g., a combined point cloud representing the 360° environment around the vehicle). Accordingly, since the controller can effectively integrate the set of sensors into one unit, the distributed sensor system can replace the single 360° LIDAR device without changing or updating the vehicle system or software.

Moreover, the controller can adjust the performance level and/or sensitivity of a subset of sensors according to the vehicle's context and the relevant areas. Accordingly, the controller can reduce the performance level or sensitivity of less-relevant areas (e.g., for sensors facing the rear when the vehicle is traveling forward). The directional control of the performance level based on the vehicle's context can thereby provide sufficient and relevant sensor data while reducing the overall power and/or processing resource consumption, such as in comparison to operating the single 360° LIDAR device that applies the same performance level all around the vehicle including the less relevant zones.

### 5. Conclusion

From the foregoing, it will be appreciated that specific embodiments of the technology have been described herein for purposes of illustration, but that various modifications can be made without deviating from the technology. In representative embodiments, the LIDAR devices and/or the controller can have configurations other than those specifically shown and described herein, including other semiconductor constructions. The various circuits described herein may have other configurations in other embodiments, which also produce the desired characteristics (e.g., anti-saturation) described herein.

Certain aspects of the technology described in the context of particular embodiments may be combined or eliminated in other embodiments. Further, while advantages associated with certain embodiments of the technology have been described in the context of those embodiments, other embodiments may also exhibit such advantages, and not all embodiments need necessarily exhibit such advantages to fall with within the scope of the present technology. Accordingly, the present disclosure and associated technology can encompass other embodiments not expressly shown or described herein. For example, while processes or blocks are presented in a given order, other embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

To the extent any materials incorporated herein conflict with the present disclosure, the present disclosure controls.

At least a portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

1. A system for detecting an environment around a mobile platform, the system comprising:
a plurality of distance measurement devices, with individual distance measurement devices coupled to the mobile platform at corresponding different locations, wherein the individual distance measurement devices are configured to generate corresponding individual distance measurement data sets representative of distances between the mobile platform and features of the environment; and
a controller coupled to the plurality of distance measurement devices, wherein the controller comprises an interface to an external computing device, and wherein the controller is configured to:
receive the individual distance measurement data sets from the plurality of distance measurement devices,
calculate, based on the individual distance measurement data sets, a combined distance measurement data set representative of at least a portion of the environment around the mobile platform,
communicate the combined distance measurement data set to the external computing device via the interface,
receive status data from at least one distance measurement device, wherein the status data comprises one or more of power data or error data for the at least one distance measurement device,
transmit a control signal in response to the status data,
receive context data indicative of a state of one or more of the mobile platform or the environment, and
transmit a mode switch signal to the plurality of distance measurement devices in response to the context data, wherein the mode switch signal causes the plurality of distance measurement devices to operate according to an operating mode.

2. The system of claim 1, wherein the controller includes a printed circuit board.

3. A system for detecting an environment around a mobile platform, the system comprising:
a plurality of distance measurement devices, with individual distance measurement devices coupled to the mobile platform at corresponding different locations, wherein the individual distance measurement devices are configured to generate corresponding individual distance measurement data sets representative of distances between the mobile platform and features of the environment; and
a controller coupled to the plurality of distance measurement devices, wherein the controller includes:
a printed circuit board,
a control hub attached to the printed circuit board and operably coupled to the plurality of distance measurement devices, the control hub being configured to communicate one or more control signals, one or more status data, or a combination thereof to and/or from the plurality of distance measurement devices, and
a data hub attached to the printed circuit board and operably coupled to the plurality of distance measurement devices, the data hub being configured to receive and process the individual distance measurement data sets from each of the plurality of distance measurement devices.

4. The system of claim 3, wherein the controller is further configured to calculate, based on the individual distance measurement data sets, a combined distance measurement data set representative of at least a portion of the environment around the mobile platform.

5. The system of claim 4, wherein the controller includes a common interface to communicate the combined distance measurement data set to an external computing device.

6. The system of claim 3, wherein the mobile platform is an unmanned vehicle, an autonomous vehicle, or a robot.

7. The system of claim 3, wherein the plurality of distance measurement devices comprises at least one Light Detection and Ranging (LIDAR) device.

8. The system of claim 3, wherein the different locations comprise two or more of: an upper portion of the mobile platform, a lower portion of the mobile platform, a front portion of the mobile platform, a rear portion of the mobile platform, a central portion of the mobile platform, or a side portion of the mobile platform.

9. The system of claim 3, wherein the individual distance measurement data sets comprise point cloud data.

10. The system of claim 3, wherein the individual distance measurement data sets comprise different individual coordinate reference frames, and wherein the controller is configured to convert the individual distance measurement data sets into a single coordinate reference frame.

11. The system of claim 3, wherein the combined distance measurement data set covers a larger field of view than the individual distance measurement data sets.

12. The system of claim 3, further comprising a power supply and a plurality of protection circuits, wherein the individual distance measurement devices are connected to the power supply via corresponding individual protection circuits.

13. The system of claim 3, wherein the controller is further configured to receive and process the status data including one or more of power data or error data for the plurality of distance measurement devices.

14. The system of claim 12, wherein the status data comprises power data, and the power data comprises a current value between the power supply and the individual distance measurement devices.

15. The system of claim 14, wherein if the current value exceeds a threshold value, the control signal is transmitted to the corresponding individual protection circuits to cause the corresponding individual protection circuit to disconnect the corresponding individual distance measurement device from the power supply.

16. The system of claim 12, wherein the status data comprises power data, and the power data comprises a voltage value at the individual distance measurement devices.

17. The system of claim 12, wherein the status data comprises error data, and the error data is indicative of whether the individual distance measurement devices are in an error state.

18.-26. (canceled)

27. A method for detecting an environment around a mobile platform, the method comprising:
receiving, from a plurality of distance measurement devices coupled to the mobile platform at corresponding different locations, a corresponding plurality of distance measurement data sets representative of corresponding distances between the mobile platform and features of the environment;
calculating, based on the plurality of distance measurement data sets, a combined distance measurement data set representative of at least a portion of the environment around the mobile platform;
receiving status data from at least one distance measurement device, wherein the status data comprises one or more of power data or error data for the at least one distance measurement device; and
transmitting a control signal in response to receiving the status data.

28. (canceled)

29. (canceled)

30. The method of claim 27, wherein the plurality of distance measurement data sets comprise a corresponding plurality of different coordinate reference frames, and wherein the method further comprises converting the plurality of distance measurement data sets into a single coordinate reference frame.

31. The method of claim 30, further comprising:
receiving a corresponding plurality of calibration parameters for the plurality of distance measurement devices; and
converting the plurality of distance measurement data sets into the single coordinate reference frame based on the plurality of calibration parameters.

32.-59. (canceled)
